(19) United States
(12) Patent Application Publication
(10) Pub. No.: US 2015/0278360 A1
(43) Pub. Date: Oct. 1, 2015

(54) COMPUTING APPARATUS FOR DATA DISTRIBUTION SERVICE AND METHOD OF OPERATING THE SAME

(71) Applicant: Electronics and Telecommunications Research Institute, Daejeon (KR)

(72) Inventors: Yong Yeon KIM, Daejeon (KR); Soo Hyung LEE, Daejeon (KR); Hyung Kook JUN, Daejeon (KR); Kyung Il KIM, Daejeon (KR); Kyeong Tae KIM, Daejeon (KR); Je Man PARK, Seoul (KR); Woo Suk CHA, Jeollanam-do (KR); Won Tae KIM, Asan-si Chungcheongnam-do (KR)

(21) Appl. No.: 14/618,652

(22) Filed: Feb. 10, 2015

(30) Foreign Application Priority Data
Mar. 28, 2014 (KR) 10-2014-0036582

(51) Int. Cl. G06F 17/30

(52) U.S. Cl. CPC G06F 17/30864

(57) ABSTRACT

Disclosed are a computing apparatus for providing an entity search means so as to perform data communication between different entities of a Data Distribution Service (DDS) in a multi-network domain environment, and a method of operating the same. A method of operating a computing system for a Data Distribution Service (DDS) service in a DDS system including a first network domain and a second network domain includes: searching for search information of DDS entities included in the first network domain; determining at least a DDS entity among the DDS entities as a representative entity of the first network domain; and providing the search information of the DDS entities to a representative entity of the second network domain through the representative entity of the first network domain.

### CROSS-REFERENCE TO RELATED APPLICATIONS

This application is based on and claims priority from Korean Patent Application No. 10-2014-0036582, filed on Mar. 28, 2014, with the Korean Intellectual Property Office, the disclosure of which is incorporated herein in its entirety by reference.

### BACKGROUND

1. Field

The present invention relates to a computing apparatus for a data distribution service and a method of operating the same, and more particularly, to a computing apparatus for a data distribution service, which provides an entity searching means so that data communication may be available between different data distribution service entities in a multi-network domain environment, and a method of operating the same.

2. Discussion of Related Art

A Data Distribution Service (DDS) for a real-time system is middleware having a publication or subscription specification for a distribution environment, and was created for data distribution through publication and subscription based on data in a network environment. In order to efficiently utilize the DDS, the Object Management Group (OMG) provides a middleware standard of the DDS to support data-based communication between distributed entities. The DDS may be applied to a system, such as an airfield control system, a financial transaction system, and an industrial automatic system, which requires a dynamic change of entities collecting and distributing data in real time through a network and configuring the network.

The middleware of the DDS provides an Application Program Interface (API) as a service layer present between an application program and an operating system, and the application program may easily communicate with other entities through the API. In the OMG DDS, data is distributed between entities in the form of publication or subscription of a newspaper. Each of the DDS entities may be a publisher or a subscriber.

In the meantime, when the number of DDS entities exceeds a predetermined level, it is impossible to accept all of the DDS entities only with a single network domain. That is, the predetermined number or more of addresses cannot be provided in one network domain, so that the DDS system needs to be configured by a multi-network domain. FIG. 1 is a diagram schematically illustrating a general configuration environment of a DDS system configured by a multi-network domain. Referring to FIG. 1, a plurality of network domains 11, 12, 13, 14 including a plurality of DDS entities 11a, 12a, 13a, and 14a, respectively, is illustrated. However, the DDS system 10 in the related art cannot sufficiently provide a means for searching for the DDS entities included in the different network domains. Accordingly, it is difficult to effectively search for the DDS entities distributed in the multi-network domain, and as a result, there is a problem in that the DDS communication is not properly performed under the multi-network domain environment.

### SUMMARY

The present invention has been made in an effort to provide a computing system capable of effectively searching for distributed DDS entities in a DDS system configured by a multi-network domain, and a method of operating the same.

Further, the present invention has been made in an effort to provide a computing apparatus, which effectively searches for DDS entities within a multi-network domain so as to appropriately perform DDS communication performed under a multi-network domain environment, and a method of operating the same.

Further, the present invention has been made in an effort to provide an apparatus for implementing an active imaging system.

An exemplary embodiment of the present invention provides a method of operating a computing system for a Data Distribution Service (DDS) service in a DDS system including a first network domain and a second network domain, including: searching for search information of DDS entities included in the first network domain; determining at least a DDS entity among the DDS entities as a representative entity of the first network domain; and providing the search information of the DDS entities to a representative entity of the second network domain through the representative entity of the first network domain.

The searching for the search information of the DDS entities may include: determining whether the computing apparatus is the representative entity of the first network domain by referring to the collected search information of the DDS entities; and selectively storing the entirety or a part of the collected search information of the DDS entities according to a result of the determination.

The determining whether the computing apparatus is the representative entity of the first network domain may include determining whether the computing apparatus is the representative entity of the first network domain by referring to a Global Unique IDentifier (GUID) of the computing apparatus.

The determining of at least a DDS entity among the DDS entities as the representative entity of the first network domain may include: determining whether an existing representative entity is present in the first network domain; and determining at least one of the DDS entities included in the first network domain as the representative entity of the first network domain when the existing representative entity is not present in the first network domain as a result of the determination.

The determining whether the existing representative entity is present in the first network domain includes determining whether the existing representative entity is present in the first network domain by referring to whether a GUID of the representative entity is included in the collected search information of the DDS entities.

The determining of at least a DDS entity among the DDS entities as the representative entity of the first network domain further may include storing information about the existing representative entity when the existing representative entity is present in the first network domain as a result of the determination.

The providing of the search information of the DDS entities to the representative entity of the second network domain may include: obtaining information about the representative entity of the second network domain; and transmitting the search information of the DDS entities to the representative entity of the second network domain by referring to the obtained information about the representative entity of the second network domain.

The GUID of the representative entity of the first network domain may be provided to the representative entity of the second network domain together with the search information of the DDS entities.

The providing of the search information of the DDS entities to the representative entity of the second network domain may further include re-transmitting the search information collected from the DDS entities to the representative entity of the second network domain for each predetermined period or whenever the search information of the DDS entities is updated, after the search information of the DDS entities is transmitted.

The method may further include: managing the collected search information of the DDS entities as a first group; and managing the search information of the second network domain received from the representative entity of the second network domain as a second group which is different from the first group.

The method may further include: determining whether the search information managed as the first group or the second group is updated; and providing at least a DDS entity included in the first network domain with at least a part of the search information managed as the second group as a result of the determination on the update.

The search information of the DDS entities may be provided to the representative entity of the second network domain in the form of a Participant Discovery Protocol (PDP) data list or an Endpoint Discovery Protocol (EDP) data list.

Another exemplary embodiment of the present invention provides a computing apparatus for a Data Distribution Service (DDS), including: a search information collection unit configured to search for search information of DDS entities included in a first network domain; a domain representative determination unit configured to determine at least a DDS entity among the DDS entities as a representative entity of the first network domain; and a communication unit configured to provide a representative entity of a second network domain, which is different from the first network domain, with the search information of the DDS entities through the representative entity of the first network domain.

The computing apparatus may further include a search information management unit configured to classify the collected search information of the DDS entities and search information of the second network domain received from the representative entity of the second network domain into two or more groups and manage the search information.

According to the exemplary embodiments of the present invention, in the DDS system configured by a multi-network domain, it is possible to effectively search for DDS entities included in different network domains through representative entities.

Further, it is possible to appropriately perform DDS communication under a multi-network domain environment based on the entity search method.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a diagram schematically illustrating a general configuration environment of a DDS system configured by a multi-network domain;

FIG. 2 is a block diagram schematically illustrating a configuration of a computing apparatus for a DDS according to an exemplary embodiment of the present invention;

FIG. 3 is a flowchart illustrating an example of an operation method of a domain representative determination unit 110 illustrated in FIG. 2 of the present specification;

FIG. 4 is a flowchart illustrating an example of an operation method of a search information collection unit 120 illustrated in FIG. 2 of the present specification;

FIG. 5 is a flowchart illustrating an example of an operation method of a communication unit 140 illustrated in FIG. 2 of the present specification;

FIG. 6 is a flowchart illustrating an example of an operation method of a search information management unit 130 illustrated in FIG. 2 of the present specification; and

FIG. 7 is a block diagram schematically illustrating a configuration environment of a DDS system according to an exemplary embodiment of the present invention.

FIG. 8 is a block diagram illustrating an example of an apparatus to which an embodiment of the present invention may be applied.

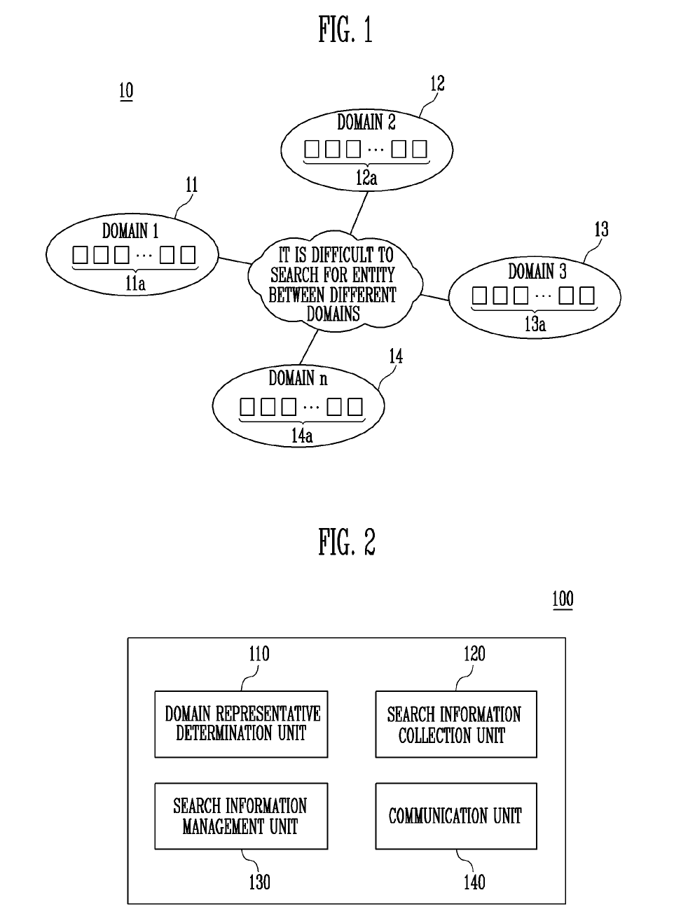

### DETAILED DESCRIPTION

The present invention will be described with reference to the accompanying drawings based on a specific embodiment in which the present invention may be carried out as an example. It should be understood that various embodiments of the present invention are different from each other, but need not to be mutually exclusive. For example, a specific figure, a structure, and a characteristic described herein may be implemented as another embodiment without departing from a spirit and a scope of the present invention in relation to an embodiment.

Further, it should be understood that a position or a displacement of an individual constituent element in each disclosed embodiment may be changed without departing from the spirit and the scope of the present invention. Accordingly, the detailed description below is not intended as a limit meaning, and the scope of the present invention is defined by the accompanying claims in principle, and includes the matters described in the claims and exemplary embodiments within an equivalent scope thereto. When like reference numerals are used in the drawings, the like reference numerals denote the same or similar functions in several exemplary embodiments.

Hereinafter, contents and a spirit of the present invention will be described through a particular exemplary embodiment with reference to the accompanying drawings.

FIG. 2 is a block diagram schematically illustrating a configuration of a computing apparatus for a Data Distribution Service (DDS) according to an exemplary embodiment of the present invention. Referring to FIG. 2, a computing apparatus 100 for a DDS includes a domain representative determination unit 110, a search information collection unit 120, a search information management unit 130, and a communication unit 140.

In the present invention, each of the network domains configuring a DDS system includes at least one representative entity. The representative entity is selected or determined from among a plurality of entities included in the network domains, and the DDS system of the present invention searches for the DDS entities within different network domains through the selected or determined representative entity. In the meantime, the DDS entities are entities included in the DDS system of the present invention or participating in DDS communication of the present invention, and mean DDS communication middleware entities.

The computing apparatus 100 illustrated in FIG. 2 means a DDS entity included in the DDS system of the present invention or a computing apparatus configuring the DDS entity. In this case, all of the DDS entities within the network domains need not to be essentially configured to be identical to the computing apparatus 100 of FIG. 2. For example, some of the DDS entities included in one network domain may be configured to be identical to that of FIG. 2, and the rest of the DDS entities may be configured to be identical to general DDS entities in the related art.

Hereinafter, each of the constituent elements of the computing apparatus 100 will be described in more detail.

The domain representative determination unit 110 is a module for determining a representative entity for performing or relaying a search for a DDS entity between different network domains. The search information management unit 110 collects Global Unique IDentifiers (GUID) of DDS entities included in a network domain, to which the computing apparatus 100 belongs, and determines a representative entity based on the collected GUIDs. For example, the search information management unit 110 analyzes the GUID, and when it is determined that there is no representative entity, or there is a representative entity originally, but the representative entity is presently withdrawn, the search information management unit 110 determines a new representative through a predetermined representative determination algorithm.

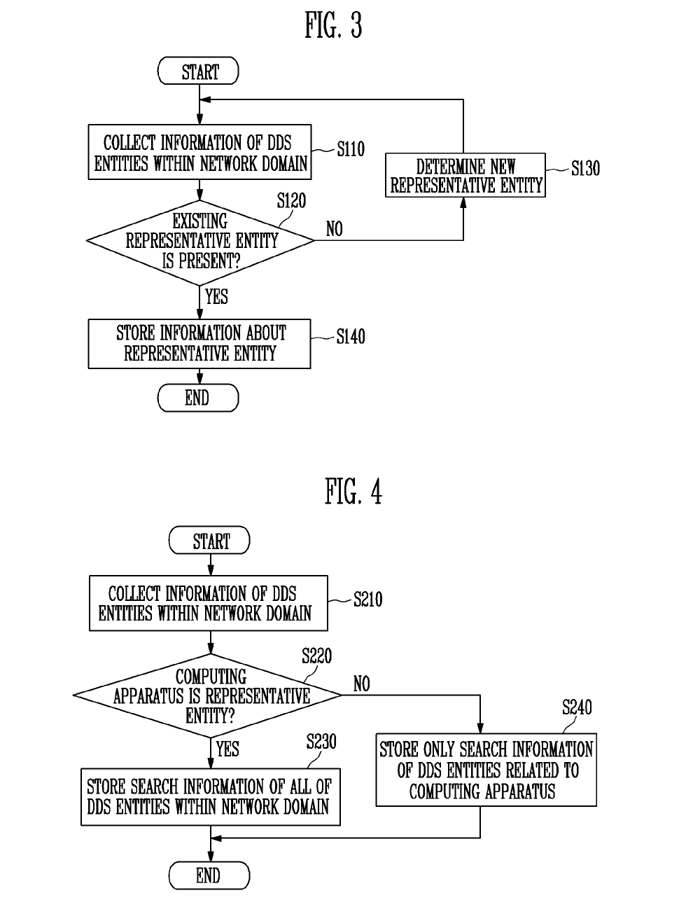

A particular operation method of the search information management unit 110 and a particular example of the representative determination algorithm will be described below with reference to FIG. 3.

The search information collection unit 120 is a module for collecting search information of the DDS entities included in the network domain to which the computing apparatus 100 belongs. The search information collection unit 120 may store the entirety or a part of the collected search information, and provide another DDS entity within the network domain of the computing apparatus 100 or a representative entity of another network domain with the collected or stored search information.

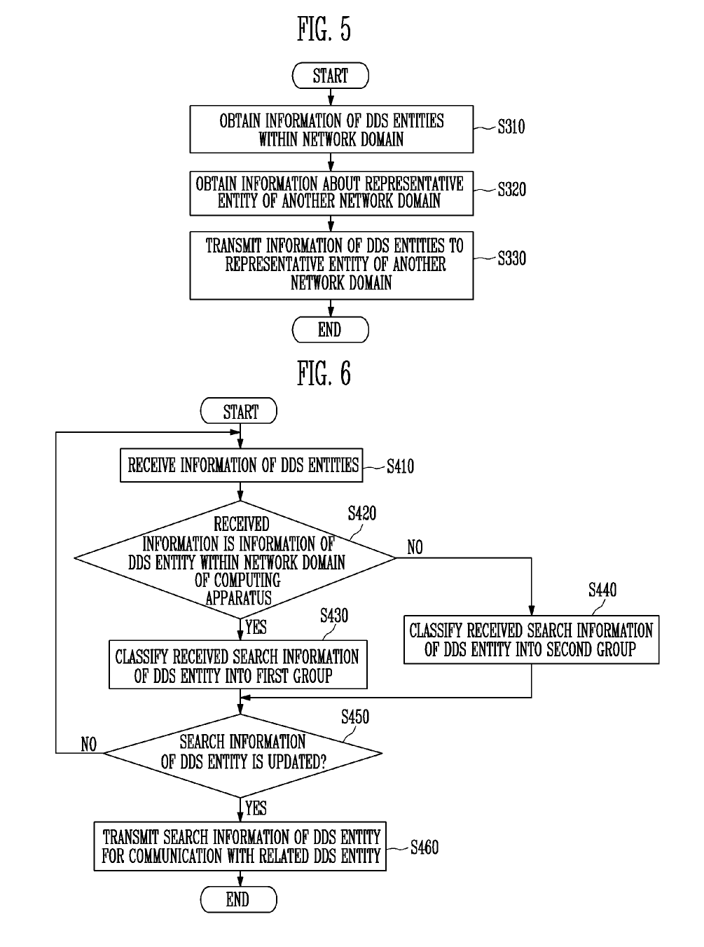

A particular operation method of the search information collection unit 120 will be described below in more detail with reference to FIG. 4.

The search information management unit 130 classifies or manages search information of the DDS entities collected by the computing apparatus 100. In this case, the search information classified or managed by the search information management unit 130 may include search information of the DDS entities within another network domain, as well as the search information of the DDS entities within the network domain to which the computing apparatus 100 belongs. In this case, the search information of the DDS entities within another network domain are the search information collected through external communication with another network domain, and may be transmitted from a representative entity of another network domain.

The search information management unit 130 may generate or manage each list for the search information collected in the network domain to which the computing apparatus 100 belongs, and the search information collected from another network domain, and transmit the search information collected from another network domain to other DDS entities included in the network domain to which the computing apparatus 100 belongs. As an exemplary embodiment, the search information management unit 130 may be configured to be operated only when the computing apparatus 100 is the representative entity.

A particular operation method of the search information management unit 110 will be described below in more detail with reference to FIG. 6.

The communication unit 140 performs external communication with another network domain. The communication unit 140 may communicate with a representative entity of another network domain, and receive search information of a DDS entity of another network domain, or transmit the search information of the DDS entity collected by the computing apparatus 100 to another network domain. As an exemplary embodiment, the communication unit 140 may be configured to be operated only when the computing apparatus 100 is the representative entity.

The communication unit 140 communicates with a DDS entity of another network domain by using a wired or wireless communication means. In this case, the wired or wireless communication means may include one or more communication means selected from the group consisting of a Local Area Network (LAN), a Metropolitan Area Network (MAN), a Global System for Mobile Network (GSM), an Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, a Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX), and ultrasonic communication.

A particular operation method of the communication unit 140 will be described below in more detail with reference to FIG. 5.

The computing apparatus 100 according to the configuration illustrated in FIG. 2 first collects search information of the DDS entities included in its network domain through the search information collection unit 120. In this case, the search information of the DDS entities is collected by using a Participant Discovery Protocol (PDP), which is a standard for searching for another DDS entity, and an Endpoint Discovery Protocol (EDP) for searching for an endpoint which directly transmits and receives data.

Particularly, DDS middleware is divided into a higher layer of Data-Centric Publish-Subscribe (DCPS) a lower layer of Real-Time Publish Subscribe (RTPS). The DCPS defines a common interface provided to an application program and a service quality for data distribution in the publication and subscription scheme. The RPTS directly transmit data to a User Datagram Protocol/Internet Protocol layer or receives data from the UDP/IP layer according to the common interface defined by the DCPS. The RTPS provides an entity search function of searching for DDS entities in a distribution network environment, and the RTPS uses the aforementioned PDP and EDP during the process. Contents related to the DCPS, the RTPS, the PDP, and the EDP of the DDS middleware, and a particular method of collecting the search information of DDS entities within a single network domain by using the DCPS, the RTPS, the PDP, and the EDP are widely known to the art, so that detailed descriptions thereof will be omitted.

Further, when the search information of the DDS entities within the network domain to which the computing apparatus 100 belongs is collected, the computing apparatus 100 determines a representative entity through the domain representative determination unit 110. As a result of the determination of the representative entity, when the computing apparatus 100 is determined as the representative entity, the computing apparatus 100 provides a representative entity of another network domain with the search information collected by the computing apparatus 100 via an external communication network through the communication unit 140. As an exemplary embodiment, the search information provided in this case may be provided in the form of a DPD list or an EDP list for the DDS entities. By contrast, when another DDS entity, not the computing apparatus 100, is determined as the representative entity, the computing apparatus 100 may be left in a standby state for performing a next command or provide the DDS entity, which is determined as the representative entity, with the search information collected by the computing apparatus 100.

Further, the representative entity of another network domain receives the search information provided by the computing apparatus 100, and transmits or distributes the received search information to other DDS entities within another network domain (that is, the network domain to which the representative entity receiving the search information belongs).

By contrast, the computing apparatus 100 may receive search information of another network domain from the representative entity of another network domain. In this case, the computing apparatus 100 receives search information from a representative entity from another network domain through the communication unit 140, and transmits or distributes the received search information to other DDS entities of the network domain to which the computing apparatus 100 belongs. As an exemplary embodiment, the search information received in this case may be received in the form of a DPD list or an EDP list for the DDS entities.

In the meantime, when the computing apparatus 100 provides a representative entity of another network domain with the search information collected by the computing apparatus 100, or transmits or distributes search information received from a representative entity of another network domain to the DDS entities, the computing apparatus 100 may classify and manage the search information collected by the computing apparatus 100 or received through the search information management unit 130. For example, the computing apparatus 100 may separately classify the search information received from another network domain as external search information through the search information management unit 130, and selectively transmit or distribute only the classified external search information to other DDS entities. Otherwise, the computing apparatus 100 may separately classify the search information collected from its network domain as internal search information through the search information management unit 130, and selectively provide a representative entity of another network domain with only the classified internal search information.

According to the aforementioned exemplary embodiment of the present invention, a representative entity serving to exchange entity search information between different network domains may be set, thereby effectively searching for DDS entities belonging to other network domains in the DDS system configured by a multi-network domain. Further, it is possible to effectively perform DDS communication under the multi-network domain environment based on the entity search method.

FIG. 3 is a flowchart illustrating an example of an operation method of the domain representative determination unit 110 illustrated in FIG. 2 of the present specification. Referring to FIG. 3, an operation method of the search information management unit 110 includes operations S110 to S140.

In operation S110, the search information management unit 110 collects search information of DDS entities within a network domain to which the computing apparatus 100 belongs. As an exemplary embodiment, the search information of the DDS entities may be performed by using the search information collection unit 120.

In operation S120, the search information management unit 110 analyzes the collected search information, and determines whether there is an existing representative entity within the network domain to which the computing apparatus 100 belongs. As an exemplary embodiment, the search information management unit 110 may determine whether the representative entity is present by a method of reading GUIDs of the DDS entities from the search information, and determining whether there is a representative GUID among the read GUIDs.

When there is no representative entity, the operation method of the search information management unit 110 proceeds to operation S130. Otherwise, the operation method of the search information management unit 110 proceeds to operation S140.

In operation S130, the search information management unit 110 determines a new representative entity. In this case, the search information management unit 110 may determine a new representative entity through a predetermined representative determination algorithm. The representative determination algorithm may be variously configured.

For example, the representative determination algorithm may be configured so that the DDS entity having higher priority becomes a representative entity by assigning priority to each of the DDS entities belonging to the network domain. Otherwise, the representative determination algorithm may be configured so that the DDS entity having higher priority becomes a representative entity by assigning priority to each of the DDS entities in an order of subscription or participation to the network domain Otherwise, the representative determination algorithm may be configured so that the DDS entity having more excellent performance becomes a representative entity by receiving performance information about each of the DDS entities belonging to the network domain Otherwise, the representative determination algorithm may be configured by a method of simply determining a predetermined DDS entity among the DDS entities belonging to the network domain as a representative domain.

When a new representative entity is determine, the operation method of the search information management unit 110 returns to operation S110 and re-performs operation S110 of collecting the search information of the DDS entities.

In operation S140, the search information management unit 110 stores information about the representative entity. The stored information about the representative entity may be referred when the computing apparatus 100 transmits the representative entity with its search information or the entity information later.

According to the aforementioned configuration, the representative entity may be determined among the DDS entities within the network domain to which the computing apparatus 100 belongs.

FIG. 4 is a flowchart illustrating an example of an operation method of the search information collection unit 120 illustrated in FIG. 2 of the present specification. Referring to FIG. 4, an operation method of the search information collection unit 120 includes operations S210 to S240.

In operation S210, the search information collection unit 120 collects search information of DDS entities within a network domain to which the computing apparatus 100 belongs.

In operation S220, the search information collection unit 120 determines whether the computing apparatus 100 is a representative entity. As an exemplary embodiment, the search information collection unit 120 may determine whether the computing apparatus 100 is the representative entity by referring to GUIDs of the computing apparatus 100. When the computing apparatus 100 is the representative entity, the operation method of the search information collection unit 120 proceeds to operation S230. Otherwise, the operation method of the search information collection unit 120 proceeds to operation S240.

In operation S230, the search information collection unit 120 collects search information collected by the search information collection unit 120, and for all of the DDS entities within the network domain to which the computing apparatus 100 belongs. In this case, the stored search information may be provided to a representative entity of another network domain through the communication unit 140 later.

In operation S240, the search information collection unit 120 stores only the search information of the DDS entity related to the computing apparatus 100. In this case, the DDS entity related to the computing apparatus 100 means a DDS entity at least partially involved in publication or subscription of the data of the computing apparatus 100, such as a relationship between a publisher and a subscriber for one piece of data, a relationship in which each of the computing apparatus 100 and the DDS entity publishes the same data, a relationship in which each of the computing apparatus 100 and the DDS entity receives the same data, and a relationship in which, when one of the computing apparatus 100 and the DDS entity publishes data, the other one is involved in a transmission path of the data.

According to the aforementioned configuration, the search information of the DDS entities within the network domain to which the computing apparatus 100 belongs may be collected and stored.

FIG. 5 is a flowchart illustrating an example of an operation method of the communication unit 140 illustrated in FIG. 2 of the present specification. Referring to FIG. 5, an operation method of the communication unit 140 includes operations S310 to S330.

In operation S310, the communication unit 140 obtains search information of DDS entities within a network domain to which the computing apparatus 100 belongs. In this case, the obtained search information may be search information collected through the search information collection unit 120.

In operation S320, the communication unit 140 may obtain information about a representative entity of another network domain (that is, a network domain different from the network domain to which the computing apparatus 100 belongs). In this case, the obtained information about the representative entity may include a network address of the representative entity of another network domain, the GUID, or the different types of identifier.

In operation S330, the communication unit 140 transmits the obtained search information of the DDS entities to the representative entity of another network domain by referring to the obtained information about the representative entity of another network domain.

As an exemplary embodiment, when the communication unit 140 transmits the search information of the DDS entities to the representative entity of another network domain, the communication unit 140 may transmit the search information together with the network address, the GUID, or the different type of identifier of the computing apparatus 100. In this case, the search information of the DDS entities may be transmitted in the form of a search information list.

As an exemplary embodiment, the communication unit 140 may re-transmit the obtained search information of the DDS entities to a representative entity of another network domain for every predetermined period or when the search information of the DDS entities obtained in operation S310 is updated.

According to the aforementioned configuration, the computing apparatus 100 may transmit the obtained or collected search information of the DDS entities to the representative entity of another network domain.

FIG. 6 is a flowchart illustrating an example of an operation method of the search information management unit 130 illustrated in FIG. 2 of the present specification. Referring to FIG. 6, an operation method of the search information management unit 130 includes operations S410 to S460.

In operation S410, the search information management unit 130 receives the search information of the DDS entities. In this case, the received search information may include search information (hereinafter, referred to as internal search information) for the DDS entities within the network domain to which the computing apparatus 100 belongs or search information (hereinafter, referred to external search information) for DDS entities within another network domain.

In operation S420, the search information management unit 130 determines whether the received search information is search information (that is, the internal search information) about the DDS entity belonging to the network domain to which the computing apparatus 100 belongs. When the received search information is the internal search information, the operation method of the search information management unit 130 proceeds to operation S430. When the received search information is the external search information, the operation method of the search information management unit 130 proceeds to operation S440.

In operation S430, the search information management unit 130 classifies the received search information (internal search information) for the DDS entities into a first group and manages the search information.

In operation S440, the search information management unit 130 classifies the received search information (external search information) for the DDS entities into a second group and manages the search information. In this case, the search information of the DDS entities classified into the second group and managed may be in the form of a list.

In operation S450, the search information management unit 130 determines whether the received search information of the DDS entities is updated (that is, whether the received search information of the DDS entities is different from stored existing entity information). When the received search information of the DDS entities is updated, the operation method of the search information management unit 130 proceeds to operation S460. However, when the received search information of the DDS entities is not updated, the operation method of the search information management unit 130 returns to operation S410 and newly receives the search information of the DDS entities.

In operation S460, the search information management unit 130 transmits or distributes the necessary search information to the DDS entities within the network domain, to which the computing apparatus 100 belongs, by referring to the received search information of the DDS entities so that the DDS entities within the network domain, to which the computing apparatus 100 belongs, may perform DDS communication with the DDS entity included in another network domain. For example, the computing apparatus 100 determines a relation between each DDS entity of the network domain, to which the computing apparatus 100 belongs, and each DDS entity of another network domain, and may selectively provide at least a part of the DDS entities within the network domain, to which the computing apparatus 100 belongs, with a part or the entirety of the search information of the DDS entities of the network domain included in the second group (for example, selectively provide only the search information of the previously determined DDS entities having the relation among the DDS entities of another network domain).

According to the aforementioned configuration, the computing apparatus 100 may appropriately classify and manage the collected or received search information, thereby providing the search information of the DDS entities so that the DDS entities of the network domain, to which the computing apparatus 100 belongs, may perform DDS communication with DDS entities belonging to a different network domain.

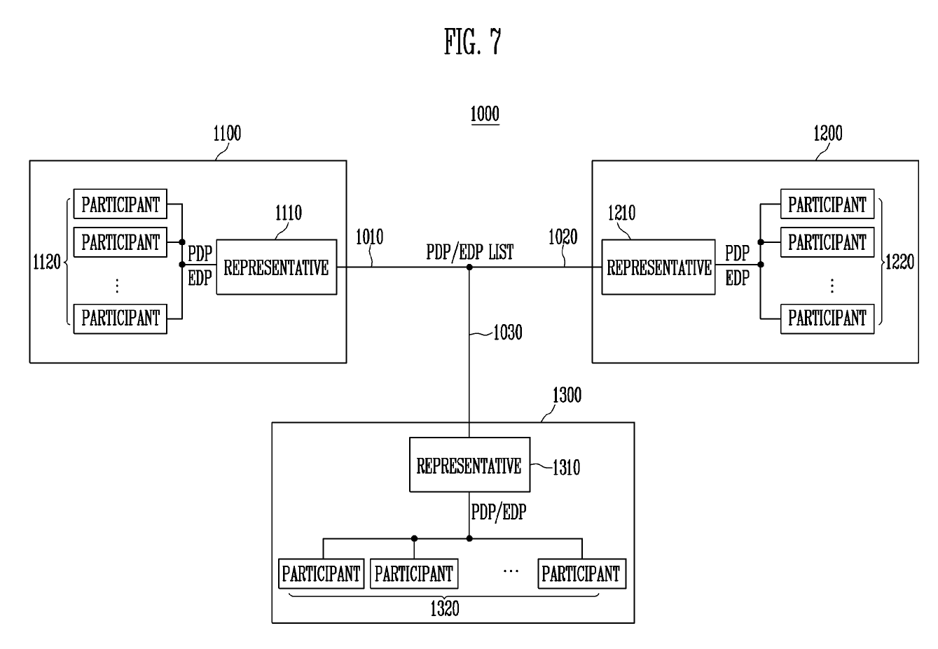

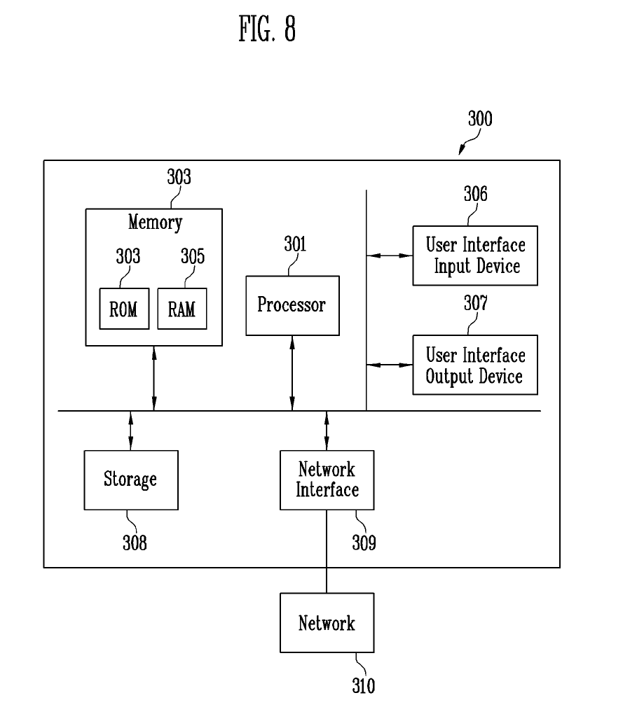

FIG. 7 is a block diagram schematically illustrating a configuration environment of a DDS system according to an exemplary embodiment of the present invention.

Referring to FIG. 7, a DDS system 1000 includes a plurality of network domains 1100, 1200, and 1300. Further, each of the network domains 1100, 1200, and 1300 includes one or more representative entities 1110, 1210, and 1310, and one or more participant entities 1120, 1220, and 1320. The plurality of network domains 1100, 1200, and 1300 configuring the DDS system 1000 may be connected so as to establish communication.

In the DDS system 1000, each of the network domains 1100, 1200, and 1300 searches for its DDS entities. The search of the DDS entities may be divided into the PDP operation of searching for participant entities participating in the DDS system 1000, and the EDP operation of searching for the endpoints for actually transceiving data through the DDS system 1000.

In the respective network domains 1100, 1200, and 1300, the search of the DDS entities may be automatically performed when the DDS system 1000 is first driven and the participant entities are generated. When the participant entities are generated, an SPDP protocol operation of periodically transmitting PDP data is performed. Further, when the endpoints serving to transmit or receive the data are generated after the PDP data for another DDS entity is received, an SEDP protocol operation of exchanging EDP data of the endpoints and sharing the data of the endpoints and Quality of Service (QoS) information is performed.

When the search of the DDS entity through the PDP and EDP data is completed in each of the network domains 1100, 1200, and 1300, the network domains 1100, 1200, and 1300 determine the representative entity 1110, 1210, and 1310, respectively, through the computing apparatus 100 (see FIG. 2) having the configuration of FIG. 2. The determined representative entities 1110, 1210, and 1310 transmit search information (for example, a list of the PDP data and the EDP data) for the DDS entities to representative entities of other network domains through communication connection 1010, 1020, and 1030 between the network domains 1100, 1200, and 1300. The representative entities 1110, 1210, and 1310 receiving the search information transmit or distribute the received search information to other participant entities 1120, 1220, and 1320 of the network domain, to which the representative entities 1110, 1210, and 1310 belong, so that the representative entities 1110, 1210, and 1310 may check the necessary search information of the DDS entity of another network domain.

According to the DDS system, a representative entity serving to exchange search information of an entity between different network domains is set for each network domain, so that it is possible to effectively search for DDS entities distributed in the respective network domains in the DDS system configured by the multi-network domain. Further, it is possible to effectively perform DDS communication under the multi-network domain environment based on the entity search method.

An embodiment of the present invention may be implemented in a computer system, e.g., as a computer readable medium. As shown in FIG. 8, a computer system 300 may include one or more of a processor 301, a memory 303, a user input device 306, a user output device 307, and a storage 308, each of which communicates through a bus 302. The computer system 300 may also include a network interface 309 that is coupled to a network 310. The processor 301 may be a central processing unit (CPU) or a semiconductor device that executes processing instructions stored in the memory 303 and/or the storage 308. The memory 303 and the storage 308 may include various forms of volatile or non-volatile storage media. For example, the memory may include a read-only memory (ROM) 304 and a random access memory (RAM) 305.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A method of operating a computing system for a Data Distribution Service (DDS) service in a DDS system including a first network domain and a second network domain, comprising:
searching for search information of DDS entities included in the first network domain;
determining at least a DDS entity among the DDS entities as a representative entity of the first network domain; and
providing the search information of the DDS entities to a representative entity of the second network domain through the representative entity of the first network domain.

2. The method of claim 1, wherein the searching for the search information of the DDS entities includes:
determining whether the computing apparatus is the representative entity of the first network domain by referring to the collected search information of the DDS entities; and
selectively storing the entirety or a part of the collected search information of the DDS entities according to a result of the determination.

3. The method of claim 2, wherein the determining whether the computing apparatus is the representative entity of the first network domain includes determining whether the computing apparatus is the representative entity of the first network domain by referring to a Global Unique IDentifier (GUID) of the computing apparatus.

4. The method of claim 1, wherein the determining of at least a DDS entity among the DDS entities as the representative entity of the first network domain includes:
determining whether an existing representative entity is present in the first network domain; and
determining at least one of the DDS entities included in the first network domain as the representative entity of the first network domain when the existing representative entity is not present in the first network domain as a result of the determination.

5. The method of claim 4, wherein the determining whether the existing representative entity is present in the first network domain includes determining whether the existing representative entity is present in the first network domain by referring to whether a GUID of the representative entity is included in the collected search information of the DDS entities.

6. The method of claim 4, wherein the determining of at least a DDS entity among the DDS entities as the representative entity of the first network domain further includes storing information about the existing representative entity when the existing representative entity is present in the first network domain as a result of the determination.

7. The method of claim 1, wherein the providing of the search information of the DDS entities to the representative entity of the second network domain includes:
obtaining information about the representative entity of the second network domain; and
transmitting the search information of the DDS entities to the representative entity of the second network domain by referring to the obtained information about the representative entity of the second network domain.

8. The method of claim 7, wherein the GUID of the representative entity of the first network domain is provided to the representative entity of the second network domain together with the search information of the DDS entities.

9. The method of claim 7, wherein the providing of the search information of the DDS entities to the representative entity of the second network domain further includes re-transmitting the search information collected from the DDS entities to the representative entity of the second network domain for each predetermined period or whenever the search information of the DDS entities is updated, after the search information of the DDS entities is transmitted.

10. The method of claim 1, further comprising:
managing the collected search information of the DDS entities as a first group; and
managing the search information of the second network domain received from the representative entity of the second network domain as a second group which is different from the first group.

11. The method of claim 10, further comprising:
determining whether the search information managed as the first group or the second group is updated; and
providing at least a DDS entity included in the first network domain with at least a part of the search information managed as the second group as a result of the determination on the update.

12. The method of claim 1, wherein the search information of the DDS entities is provided to the representative entity of the second network domain in the form of a Participant Discovery Protocol (PDP) data list or an Endpoint Discovery Protocol (EDP) data list.

13. A computing apparatus for a Data Distribution Service (DDS), comprising:
a search information collection unit configured to search for search information of DDS entities included in a first network domain;
a domain representative determination unit configured to determine at least a DDS entity among the DDS entities as a representative entity of the first network domain; and
a communication unit configured to provide a representative entity of a second network domain, which is different from the first network domain, with the search information of the DDS entities through the representative entity of the first network domain.

14. The computing apparatus of claim 13, further comprising:
a search information management unit configured to classify the collected search information of the DDS entities and search information of the second network domain received from the representative entity of the second network domain into two or more groups and manage the search information.
